(19) United States
(12) Patent Application Publication
(10) Pub. No.: US 2016/0161251 A1
(43) Pub. Date: Jun. 9, 2016

(54) METHOD FOR CHARACTERIZING THE MECHANICAL PARAMETERS OF A ROADWAY

(71) Applicants: COMMISSARIAT À L'ÉNERGIE ATOMIQUE ET AUX ÉNERGIES ALTERNATIVES, Paris (FR); COLAS, Boulogne Billancourt Cedex (FR)

(72) Inventors: Mickael CARMONA, Tencin (FR); Antoine ROBINET, Tullins (FR); Eric COQUELLE, Versailles (FR); Jean-Luc GAUTIER, Guyancourt (FR)

(73) Assignees: COMMISSARIAT À L'ÉNERGIE ATOMIQUE ET AUX ÉNERGIES ALTERNATIVES, Paris (FR); COLAS, Boulogne Billancourt Cedex (FR)

(21) Appl. No.: 14/906,925

(22) PCT Filed: Jul. 21, 2014
(86) PCT No.: PCT/EP2014/065573

§ 371 Date: Jan. 22, 2016

(30) Foreign Application Priority Data
Jul. 22, 2013 (FR) 1357212

(51) Int. Cl. G01B 21/32; E01C 1/00

(52) U.S. Cl. CPC G01B 21/32; E01C 1/002

(57) ABSTRACT

A method for characterizing k mechanical parameters of a pavement formed by a stack in a direction Z of N layers, including: a) applying a load to the pavement to deform the pavement; b) in response, measuring deformation of the pavement at various points with displacement sensors situated at each of the points; c) determining the k parameters on the basis of the measurements of the various sensors. The measuring b) is carried out by at least k sensors buried inside the pavement and distributed in at least two non-parallel directions X and Y perpendicular to the direction Z, and the c) determining of the k parameters is obtained on the basis of known boundary conditions on lateral edges of the pavement.

The invention relates to a method for characterizing mechanical parameters of a pavement. The invention also relates to an information recording medium, a device for characterizing mechanical parameters of a pavement and a pavement instrumented with this device, for the implementation of this method. The invention relates finally to a method for monitoring the appearance of a defect in a pavement.

In this description, the term “pavement” designates a track specifically configured for the travelling of wheeled vehicles, such as a road pavement, industrial pavement, a platform at a port or an aviation runway. On the other hand, a railway track is not considered to be a pavement.

There exist methods for characterizing mechanical parameters of a pavement which use a falling weight deflectometer. These methods typically comprise:

a) the application, with the aid of the deflectometer, of a load to the pavement in order to deform it,
b) in response, the measurement of the deformation of the surface of the pavement at various points with the aid of displacement sensors situated at each of these points, on the surface of the pavement,
c) the determination of the mechanical parameters of the pavement on the basis of the measurements of the various sensors and of a predetermined model relating the displacements measured by each sensor to the characteristics of the load applied during step a), this model being parametrized by the known position of the various sensors with respect to the pavement and by the mechanical parameters to be characterized.

An example of such a method is described in the article by M. Broutin et al. “TOWARDS A DYNAMICAL BACK-CALCULATION PROCEDURE FOR HWD; A FULL-SCALE VALIDATION EXPERIMENT”, 2010 FAA Worldwide Airport Technology Transfer Conference, Atlantic City, N.J., USA; April 2010. In these known methods, the sensors are typically aligned on the surface of the pavement along a single direction.

However, these methods exhibit the drawback that the accuracy and the reliability of the characterized mechanical parameters are limited, as is the bringing onto site of a dedicated instrumented vehicle.

Prior art is also known from:

Database Compendex, Engineering Information, Inc, New York, September 2012, Gonzalez A et Al: “Elastic strains, modulus and permanent deformation of foamed bitumen pavements in accelerated testing facility”. Road and Transport research September 2012 ARRB Transport Research LTD, AUS, vol. 21, No.3, September 2012, pages 64-76,
Database Compendex, Engineering Information, Inc, New York, CHEN S-X et Al: “Analysis of asphalt pavement structural response from an accelerated loading test”. Journal of Harbin Institute of technology, August 2007, Harbin Institute of Technology, Department of scientific research CN, Vol. 14, N)4, August 2007, pages 50-505,
BENEDETTO A et Al: “Elliptic model for prediction of deflections induced by a light falling weight deflectometer”, Journal of terrmachanics, Peragmon Press, Headington Hill Hall, Oxford, GB, Vol. 49, No.1, 26 October 2011, pages 1-12;

### WO2012/012903 A1.

A need therefore exists for a method for characterizing mechanical parameters of a pavement, which exhibits increased accuracy.

The invention therefore relates to a method for characterizing k mechanical parameters of a pavement, this pavement being formed by a stack in a direction Z of N layers and delimited by lateral edges, where k and N are non-zero integers, this method comprising:

a) the application of a load to the pavement in order to deform it,
b) in response, the measurement of the deformation of the pavement at various points with the aid of displacement sensors situated at each of these points,
c) the determination of the k mechanical parameters on the basis of the measurements of the various sensors and of a predetermined model relating the displacements measured by each sensor to the characteristics of the load applied during step a), this model being parametrized by the known position of the various sensors with respect to the pavement and by the k mechanical parameters to be characterized, and in which:
during step b), the measurement is carried out by at least k sensors buried inside the pavement and distributed in at least two non-parallel directions X and Y perpendicular to the direction Z. and
during step c), the determination of the k parameters is also obtained on the basis of known boundary conditions on the lateral edges of the pavement.

By measuring the displacements in at least two non-parallel directions X and Y perpendicular to the direction Z and by taking into account the boundary conditions on the lateral edges of this pavement, the mechanical characteristics of the pavement are determined with improved accuracy and improved reliability. Indeed, the applicants have discovered in a surprising manner that the taking into account of the existence of the lateral edges, whereas known methods consider that the pavement extends to infinity in all directions, substantially increases the reliability of the computations. Furthermore, the burying of the sensors in the pavement makes it possible to measure the deformations of the pavement with increased accuracy, in particular as regards the displacement of the deepest layers of the pavement.

The embodiments of the invention may exhibit one or more of the characteristics of the dependent claims.

These embodiments furthermore exhibit the following advantages:

the use of a vehicle of mass M and travelling over the pavement at a speed V, makes it possible to implement step a) without having to use a falling weight deflectometer. The implementation of step a) is thus simplified and faster since it is no longer necessary to move the deflectometer from place to place.
step a) may be implemented with a vehicle of mass M travelling over the pavement at a speed V, where the characteristics M and V are not known a priori. This makes it possible to carry out step a) in a passive manner, with any vehicle travelling naturally over the pavement, rather than with a gauge vehicle for which the characteristics M and V are previously known. Step a) and, more generally, the characterization method may thus be implemented in a passive manner, without it being necessary to close access to the pavement to vehicles travelling thereon.
the measurement of the speed V on the basis of the same sensors as those used to measure the displacement during step b) makes it possible to avoid having to use sensors dedicated to the measurement of V, thereby simplifying the implementation of the method and reducing its cost.
the modelling of the pavement using sub-models for each of its N constituent layers makes it possible to refine the accuracy of the k characterized mechanical parameters.
the moduli of elasticity make it possible to obtain information on the structural state of the pavement.

According to another aspect, the invention also relates to a method for monitoring the appearance of a defect in a pavement in accordance with Claim 8.

According to another aspect, the invention also relates to an information recording medium, comprising instructions for the execution of step c) of a method in accordance with the invention when these instructions are executed by an electronic computer.

According to another aspect, the invention also relates to a device for characterizing k mechanical parameters of a pavement in accordance with Claim 10.

According to another aspect, the invention also relates to an instrumented pavement in accordance with Claim 11.

The embodiments of the characterization device or the instrumented pavement according to the invention may exhibit the following characteristic: the said sensors comprise three-axis accelerometers.

The invention will be better understood on reading the description which follows, given solely by way of nonlimiting example and while referring to the drawings in which:

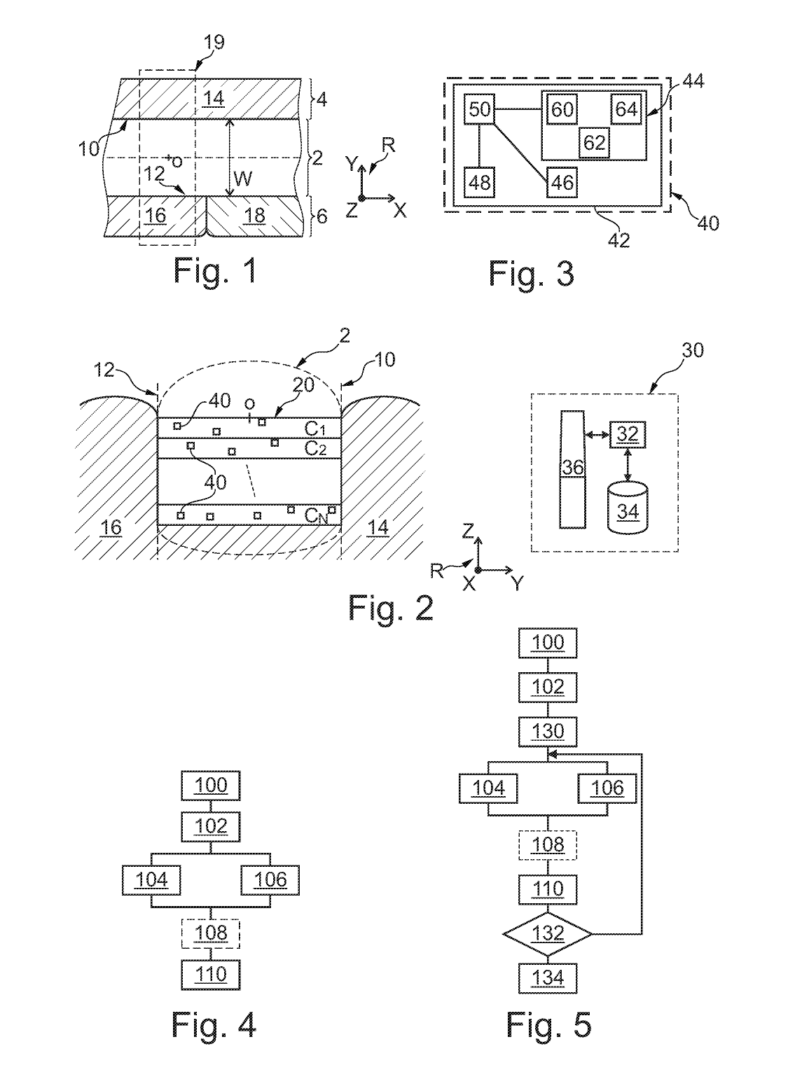

FIG. 1 is a schematic illustration, according to a view from above, of a portion of a pavement instrumented by means of a device for characterizing mechanical parameters of this pavement;

FIG. 2 is a schematic illustration, according to a transverse sectional view, of the pavement portion of FIG. 1;

FIG. 3 is a schematic illustration of a sensor of displacement of the pavement of FIG. 1;

FIG. 4 is a flowchart of a method for characterizing mechanical parameters of the pavement of FIG. 1;

FIG. 5 is a flowchart of a method for monitoring the appearance of a defect in the pavement of FIG. 1.

In these figures, the same references are used to designate the same elements.

Hereinafter in this description, characteristics and functions well known to the person skilled in the art are not described in detail.

FIG. 1 represents a pavement 2. This pavement 2 extends in mutually non-parallel directions X and Y perpendicular to a direction Z of stacking of the layers. In the example represented, the direction Z is vertical. These directions X and Y are here orthogonal and define a horizontal plane. The directions X, Y and Z here define an orthonormal frame R, fixed with respect to the pavement 2.

This pavement 2 extends here essentially longitudinally in the direction X.

The pavement 2 is delimited, in the direction Y, by kerbs 4 and 6 by lateral edges respectively 10 and 12. This pavement 2 is here rectilinear and exhibits a width W, measured in the direction Y.

By way of illustration, the kerb 4 comprises a zone 14 formed of a material. The kerb 6 comprises two distinct zones 16 and 18 immediately consecutive in the direction X. Each of these zones 16, 18 is formed of a different material. The zones 14, 16 and 18 are here each homogeneous in all directions and in particular in the direction Z. The mechanical coupling between the lateral edges 10, 12 and the zones 14, 16, 18 is presumed known or can be determined experimentally or by modelling of the kerbs. Here, for simplicity, it is considered that the zones 14, 16 are formed of a material which is only very slightly deformable relative to the materials forming the pavement 2. For example, these zones 14, 16 are identical and are made of concrete. The zone 18 is here an earth verge.

The frame R has its origin at a point O of the surface of the pavement, situated equidistantly from the edges 10 and 12. Typically, the origin of the frame R is taken at the centre of a study zone 19 to which a mechanical excitation is applied. To improve the readability of FIGS. 1 and 2, this frame R is drawn alongside the pavement 2.

The zone 19 corresponds to a portion of the pavement 2 whose mechanical characteristics it is desired to ascertain. In this example, this zone 19 is a rectangular portion of the pavement 2 whose width in the direction Y is greater than the width W of the pavement and whose length in the direction X is less than twenty or fifty metres and, preferably, less than 10 metres, five metres and, advantageously, less than two metres. Furthermore, here, inside this zone 19, the pavement 2 is bordered by portions of the kerbs 4 and 6 formed solely, respectively, of the zones 14 and 16. For simplicity, the zone 19 is not drawn to scale in FIG. 1. In this description, what follows applies in particular to this study zone 19.

FIG. 2 represents this pavement 2 in greater detail. The pavement 2 comprises a plurality of N layers, superposed contiguously one above the other in the direction Z, where N is a non-zero positive integer. These layers are here plane and mutually parallel. The layer situated at the top of this stack exhibits an upper face turned towards the exterior forming a horizontal rolling surface 20 able to receive the travelling of wheeled vehicles, such as automotive vehicles. These N layers here bear the references C₁, C₂, . . . , C_{N}, numbered consecutively, where C_{N} designates the deepest layer of the pavement. The depth is here measured in the direction Z with respect to the rolling surface 20. In this example, the number N is greater than two or three and, generally, is less than ten or twenty. The layer C₁ is for example a rolling layer with a bituminous cladding, while the layers C₂ to C_{N} are base or foundation or bonding layers serving to support the rolling layer mechanically. In this example, the layer C_{N} rests on a bed consisting of the same material as the zones 14 and 16. For example, these layers C₂ to C_{N} comprise rubble or a binder.

This pavement 2 here comprises a device for characterizing its mechanical parameters. The pavement 2 is then a so-called “instrumented pavement”.

In this example, the mechanical parameters of the pavement 2 that it is desired to characterize are the moduli of elasticity of each of the layers C₁ to C_{N} and, more precisely, the Young's modulus and the Poisson's ratio of each of the layers C₁ to C_{N}. The Young's modulus and the Poisson's ratio associated with the layer Cⱼ will be denoted Eⱼ and vⱼ respectively, where j is an integer lying between 1 and N.

The characterization device comprises:

displacement sensors 40 for measuring displacements of the pavement 2, and
a unit 30 for processing the measurements of the sensors 40.

To simplify FIG. 2, the reference 40 points only at a limited number of copies of this sensor 40.

The unit 30 comprises:

a programmable electronic processor or computer 32;
an information recording medium 34;
an interface for communication 36 with the sensors.

The interface 36 is able to collect the various measurements carried out by the sensors 40. The computer 32 executes instructions recorded in the medium 34. The medium 34 comprises, in particular, instructions for the execution of the methods of FIGS. 4 and 5.

This unit 30 is here placed on a side of the road 2, preferably in the zone 19.

Each of the sensors 40 is able to:

measure a displacement in at least three non-parallel directions, and
mechanically withstand the passage of vehicles over a pavement when it is buried inside this pavement.

The sensors 40 are situated inside the zone 19. In this example, these sensors 40 are buried in the various layers of the pavement in such away that each layer comprises, in the zone 19, a number of sensors greater than or equal to the number of mechanical parameters to be characterized for this layer. Here, each layer therefore comprises, inside the zone 19, at least two sensors 40. Preferably, each layer comprises, inside the zone 19, at least three sensors 40, mutually non-aligned. The position of these sensors 40 with respect to the pavement is known or determinable. Sensors 40 are here distributed within each layer along at least two different horizontal directions. Thus the sensors 40 are not aligned along one and the same axis inside the zone 19. Preferably, the sensors 40 are distributed so as not to all be concentrated at one and the same point of the pavement. This sensor 40 furthermore comprises an identifier making it possible to identify, in a unique manner, preferably contactlessly, each copy of the sensor 40 among the assembly of sensors 40 present inside the pavement 2.

By burying the sensors 40 inside the pavement 2, the accuracy of the measurement of the displacement undergone by the pavement is increased, in particular in the deepest layers, with respect to the case where the sensors are placed only at the surface of the pavement.

Here, all the sensors 40 are identical. Consequently, just one of these sensors 40 will now be described in detail, with reference to FIG. 3. This sensor 40 comprises here:

a shell 42 inside which are housed all the components of the sensor 40;
a measurement assembly 44;
a communication interface 46;
a power supply module 48;
a control module 50, connected up, in particular, to the assembly 44 and to the interface 46.

The shell 42 is able to withstand the steps of pavement fabrication, such as compacting or contact with hot asphalt during the making of the pavement. The shell 42 is also able to withstand the passage of vehicles over the pavement, in particular the passage of heavy vehicles or industrial plant (such as container carriers) exhibiting an axle load of greater than two or five tonnes and less than or equal to one hundred and twenty tonnes. This shell 42 advantageously exhibits a small volume so as not to degrade the properties or the shape of the pavement when the sensor 40 is buried inside the pavement. This volume is for example less than or equal to 20 cm³ or to 10 cm³ and, preferably, less than or equal to 5 cm³ or 2 cm³. Here this volume exhibits a cubic or spherical shape.

The assembly 44 is in particular able to measure a displacement in at least three non-parallel directions. Typically, these three directions are mutually orthogonal. The assembly 44 comprises for this purpose a transducer 60 able to measure a physical magnitude representative of the local displacement of the sensor 40 in the pavement. For example, the transducer 60 is a three-axis accelerometer marketed by the company “STMicroelectronics” under the reference “LSM303DLH”. Although the accelerometer does not measure a displacement directly, this displacement can be computed in a known manner on the basis of the acceleration measured, for example by integrating the measured acceleration with respect to time. This transducer 60 is here able to measure a displacement of between 1 μm and 1 mm and, preferably, of between 10pm and 500 μm. Advantageously, the assembly 44 furthermore comprises a temperature probe 62, such as the sensor marketed by the company “Colibrys” under the reference “MS9002”. In this example, the assembly 44 also comprises a three-axis magnetometer 64.

The distance between the sensors 40 is in particular chosen as a function of the sensitivity of each of the transducers 60. In practice, in this example, the transducers 60 have a sensitivity such that the transducers 60 situated further than ten or fifteen metres from the point where an excitation producing a displacement is applied do not measure any displacement.

The interface 46 is able to transfer measured data to the interface 36. This interface 46 here comprises an RFID antenna, such as the antenna described in patent application WO 2011/157941 A1. This interface 46 is advantageously configured to provide the identifier of the sensor 40 at the same time as the measurements carried out by the assembly 44.

The module 48 electrically powers the assembly 44, the interface 46 and the module 50. This module 48 comprises for example a battery or an energy recovery device (“energy harvesting”).

The module 50 is here a micro-controller.

The pavement 2 is modelled by means of a predetermined model M_{G}. This model M_{G} relates the local displacements of this pavement at a point to the characteristics of a mechanical excitation applied to this pavement in order to deform it. This model M_{G} is parametrized by mechanical parameters of the pavement including, in particular, k mechanical parameters of the pavement 2, corresponding here to the Young's moduli E₁ to E_{N} and to the Poisson's ratios v₁ to v_{N}. Hence, in this embodiment, k is equal to 2*N. This model M_{G} here takes the form of one or more differential equations (or, more precisely, of partial differential equations) involving time. For any point I of the pavement 2, the model relates the characteristics of the mechanical excitation applied in the zone 19, to the displacement of this point I obtained in response to this excitation. Subsequently, the position of the point I in the frame R is denoted Xᵢ.

Here, the mechanical excitation is produced by the passage over the surface 20 of a vehicle of mass M moving over this pavement 2 at a constant speed V. The mass M and the speed V are here the characteristics of the mechanical excitation.

In this example, the pavement 2 is modelled by modelling the individual behaviour of each layer Cⱼ by a predetermined sub-model Mⱼ of this layer. This sub-model Mⱼ is for example the model described in the documents “The response of a layered half-space to traffic loads moving along its surface” by H. Grundmann et al.; Archive of Applied Mechanics, vol. 69, p. 55-67. Springer-Verlag 1999 and “Dynamic effect of moving loads on road pavements: A review” by N. Beskou et al.; Soil Dynamics and Earthquake Engineering, vol. 31, p. 547-567, 2011 (section 3.2 and in particular equations 20 to 27 of this document). This sub-model Mⱼ corresponds to the following partial differential equation: μ*u_{i,ij}+(λ+μ)*μ_{j,ij}−π*üᵢ=0

For the explanation of the various terms of this equation, the reader is referred to the article by N. Beskou et al. These explanations are not repeated here. In this sub-model Mⱼ, the layer is here considered to exhibit homogeneous and isotropic mechanical properties.

Thus, for a given layer, the sub-model Mⱼ relates the displacement field of this layer to the mechanical parameters of this layer and to the characteristics of the mechanical excitation undergone by this layer. The displacement field is here defined as the set of displacements D(Xᵢ,t) measured at I points Xᵢ in the zone 19, where i=1, . . . ,I. In this sub-model Mⱼ, the k mechanical parameters are the first and second Lamé coefficients λⱼ and μⱼ of each layer Cⱼ, and not the Young's moduli Eⱼ and the Poisson's ratios vⱼ of each layer. However, there exist mathematical relations which relate these first and second Lamé coefficients λⱼ and μⱼ to the Young's modulus Eⱼ and to the Poisson's ratio vⱼ. These relations are well known and will not be repeated here.

This model involves, in addition to the k parameters, the mass density πⱼ of each layer. This mass density πⱼ is assumed known. For example, this mass density πⱼ is measured experimentally for each layer. For the layer C₁, the mechanical excitation is that applied to the surface 20 by the passage of the vehicle. For each of the lower layers, the mechanical excitation is that transmitted by the layer immediately above.

The model M_{G} is therefore a system of partial differential equations, where each equation corresponds to that of the sub-model of a layer. Subsequently, this model M_{G} is represented schematically by the following relation D(Xᵢ,t)=f(E₁, . . . , E_{N}; v₁, . . . , v_{N}; M; V; Xᵢ, t) where:

D(Xᵢ,t) is the instantaneous displacement at a point with coordinates Xᵢ of the pavement 2;
f is a function of the model;
Xᵢ the coordinates of the point I in the frame R. and
t the time variable.

Generally, on the basis of the system of partial differential equations, it is not possible to find an analytical expression for f. However, this does not prevent estimation of the values of the parameters Eᵢ, vᵢ for each layer as is explained subsequently.

Boundary conditions are added to solve the system of partial differential equations of this model. These boundary conditions are specifically chosen as a function of the configuration of the pavement 2, and in at least the directions X and Y. These boundary conditions are here defined with reference to the displacement field of each layer as follows:

1) the displacement fields of two contiguous layers are equal at the interface between these two layers;
2) the displacement field is zero at infinity in the direction X;
3) the displacement field is zero outside of the pavement beyond the edges 10 and 12 and, in particular, in the zones 14 and 16 of the kerbs, and
4) the displacement field is zero below the layer C_{N}.

Conditions 3) and 4) are justified here by the nature of the materials forming the zones 14 and 16 and the bed. Indeed, for simplicity, it is considered here that these zones 14 and 16 as well as the bed are formed of a material which is only very slightly deformable as compared with the materials forming the layers of the pavement 2.

By taking into account the boundary conditions for the displacement in the directions X and Y, and in particular along the edges 10, 12 of the pavement 2, the accuracy of the model is increased, since the influence of the kerbs on the deformation of the pavement 2 is taken into account. Hitherto, the existence of the kerbs was neglected since it was deemed to have no significant effect.

An exemplary use of the device to characterize these physical parameters of the pavement 2 will now be described, with reference to the flowchart of FIG. 4 and with the aid of FIGS. 1 and 2.

During a step 100, the pavement 2 is supplied, instrumented by means of the characterization device. For example, this pavement 2 is instrumented beforehand, by drilling thin channels inside the layers of the pavement 2 in order to implant the sensors 40 therein. The pavement 2 thus comprises the sensors 40. The absolute position of each of these sensors 40 is known here, for example, because care has been taken to log the position of each of these sensors 40 during their implantation inside the pavement 2. By absolute position is meant the position with respect to the reference frame R.

Advantageously, during a step 102, the model M_{G} is automatically acquired and the boundary conditions are defined as a function of the characteristics of the pavement 2 and of the kerbs 4 and 6. Here, the chosen boundary conditions are those described previously.

During a step 104, the pavement is excited mechanically so as to deform this pavement, for example by applying a load to the surface 20. Here, this load is applied by making a vehicle, exhibiting the mass M. travel over the surface 20 of the pavement 2 at the constant speed V. For example, the mass M is between half a tonne and one hundred and twenty tonnes per axle. Here the speed V is between 10 km/h and 150 km/h.

In parallel, during a step 106, the displacement of each of the sensors 40 is measured, in response to the excitation applied in step 104, by the accelerometer 60 of each sensor 40. Here, step 106 proceeds in part simultaneously with step 104.

More precisely, here, the displacement of each of the sensors 40 is measured. The displacement measured by the i-th sensor 40 with respect to its initial position in the pavement 2 will be denoted D(Xᵢ,t), where the index i identifies the sensor that carried out this measurement, and Xᵢ is the position of this i-th sensor in the frame R. The initial position of a sensor 40 is here the position occupied by this sensor in the absence of mechanical excitation of the pavement 2.

In this example, the excitation is applied by a vehicle moving over the surface and not by a pointwise load applied at a precise point of the pavement. The layers of the pavement 2 that are situated inside the zone 19 then undergo, in tandem with the displacement of the vehicle over the surface 20, a mechanical excitation which deforms them and which therefore causes a displacement of the sensors 40. In response, the accelerometer 60 of each sensor 40 measures the corresponding instantaneous acceleration at regular intervals to obtain a temporal series of measurements corresponding to the displacement D(Xᵢ,t) of this point Xᵢ over time. By successive recordings in the course of the excitation, the instantaneous displacement field of the assembly of sensors 40 in each layer of the pavement 2 in response to the excitation is thus measured. These successive recordings are for example carried out from the start of the excitation, with a constant sampling frequency.

Moreover, during this step 106:

the temperature is measured by each probe 62, and
the evolution over time of the local magnetic field is measured by each magnetometer 64.

Measurement of the temperature T in each layer makes it possible to ascertain under which temperature conditions each of the k parameters is obtained by the method. Indeed, the values of the parameters Eᵢ, vᵢ vary as a function of temperature.

The data measured by these sensors are advantageously transmitted to the unit 30. On completion of this step 106, the displacement field measured for each of the layers C₁ to C_{N} is available.

In this example, the mass M and the speed V of this vehicle are not known a priori. Hence, during a step 108, the speed V and the mass M are estimated on the basis of the data measured during step 106. The determination of the speed V is here carried out automatically, according to known procedures, by means of the data measured by the accelerometers 60 during step 106. Typically, known procedures are based on the correlation between signals of displacements measured at different locations by distinct sensors in response to the passage of the same vehicle. For example, the passage of the vehicle produces a displacement measured by a first sensor. This displacement is thereafter measured by a second remote sensor, a few instants later. Knowing the distance separating these two sensors and the gap separating the instants of measurement of these displacements, the speed V at which the vehicle is travelling can be estimated. Such a procedure is for example described in the document “Traffic Surveillance by Wireless Sensor Networks” by S-Y. Cheung, Department of Mechanical Engineering, University of California, Berkeley, USA, 2006.

The mass M is determined here by means of the data measured by the magnetometers 64. These data make it possible to estimate the “magnetic mass” of the travelling vehicle during step 104. By magnetic mass is meant the magnetic signature of the vehicle, for example due to the quantity of magnetic metallic substance contained in this vehicle. Thus, in parallel, during the passage of the vehicle during step 104, this magnetic signature is recorded, and then compared with a reference database so as to estimate the value of the mass M. This database comprises for example a plurality of predefined signatures each associated with the mass of a corresponding vehicle. This database is for example obtained beforehand by calibration, by making vehicles of known mass travel over the pavement and by recording their respective magnetic signature.

In this manner, the excitation of the pavement is carried out by vehicles travelling naturally over the pavement 2. The method can thus be implemented in a continuous and passive manner on a pavement 2, without it being necessary to close the pavement 2 to traffic or to mobilize specific equipment to carry out step 104. The implementation of the method is then greatly simplified.

Thereafter, during a step 110, the k physical parameters are determined automatically on the basis of the model M_{G} and of the measured displacement fields. Here, these parameters are determined by inversion of the pavement model, by means of known numerical procedures. For example, one proceeds as follows, by successive iterations.

Typically, accordingly, initial values ⁰E₁ to ⁰E_{N} and ⁰v₁ to ⁰v_{N} are firstly fixed for each of the k mechanical parameters

Next, the theoretical displacement \check{D}(x,t) is computed for each of the points I where a sensor 40 is situated and at each sampling instant on the basis of the fixed values of the mechanical parameters: \check{D}(x,t)=f(⁰E₁, . . . , ⁰E_{N}; ⁰v₁, . . . , ⁰v_{N}; M; V; x,t). This theoretical displacement is computed by solving the equations of the model M_{G} by means of numerical solution tools such as finite element procedures and by taking into account the previously fixed boundary conditions. A theoretical displacement field associated with the initial values of the mechanical parameters is thus obtained.

Thereafter, the values of the k mechanical parameters of the pavement are fitted so as to minimize the error between the measured displacement D(x,t) and the theoretical displacement \check{D}(x,t) computed previously. Here, this minimization is carried out according to the least squares criterion, by determining the values of the k mechanical parameters which minimize the following function: J(E₁, . . . , E_{N}; v₁, . . . , v_{N})=Σⱼ[D(Xⱼ, t)−f(E₁, . . . , E_{N}; v₁, . . . , v_{N}; M; V; Xⱼ, t)]², the summation being performed over the total number of sensors and where f( . . . )=\check{D}(Xⱼ,t).

In a known manner, these operations are repeated in successive iterations until the error is less than an acceptable limit. This acceptable limit is here less than 5% or than 1% and, preferably, less than 0.01%.

On completion of step 110, a value is thus available for the set of k mechanical parameters E₁ to E_{N} and v₁ to v_{N} characterizing the pavement.

An example of a method for monitoring the appearance of a defect in the pavement 2 will now be described, with reference to the flowchart of FIG. 5 and with the aid of FIGS. 1 to 4.

This method starts with steps 100 and 102 described previously.

Next, during a step 130, reference intervals are predefined for each of the k mechanical parameters of the pavement 2 that are modelled by the model M_{G}. For example, these reference intervals define value spans within each of which the k mechanical parameters is considered to exhibit a normal value, indicating a normal state of the pavement 2. On the contrary, if one of the mechanical parameters exhibits a value situated outside of the corresponding interval, this indicates a mechanical defect in the pavement.

Next, steps 104 to 110 of the method of FIG. 4 are implemented successively, to characterize these k mechanical parameters.

Thereafter, during a step 132, the values of k mechanical parameters obtained on completion of step 110 are compared with the corresponding reference intervals predefined during step 130. If at least one of the k mechanical parameters exhibits a value situated outside of the corresponding reference interval, then the pavement 2 is said to exhibit a defect. An alert is then emitted during a step 134, for example by the unit 30. On the contrary, if all the k mechanical parameters exhibit values included in their respective reference intervals, then the pavement 2 is said not to exhibit any defect. Step 104 and those following are then implemented again. Here, the implementation of these steps is triggered by each passing automotive vehicle.

Numerous other embodiments are possible.

As a variant, the direction Z is not vertical. The pavement 2 does not necessarily extend in the direction X.

The pavement model may be different. As a variant, the sub-models Mⱼ may not correspond to the various layers, one and the same sub-model encompassing for example several contiguous layers Cⱼ. The pavement 2 may also not be modelled by calling upon sub-models for each of the layers. For example, the entirety of the layers of the pavement 2 is modelled as a beam on an elastic support, by using the model described in section 3.1 of the article by N. Beskou et al. cited previously.

The number k of mechanical parameters may be different. For example, not all the layers are characterized by the same number of mechanical parameters. This is in particular the case if the values of some of these parameters are already known so that it is not necessary to estimate them again.

The layers may exhibit different shapes. For example, these layers exhibit a cambered shape in the direction Z.

The boundary conditions may be chosen differently. In particular, the boundary conditions on the edges of the road may differ as a function of the nature of the materials forming the kerbs 4 and 6.

As a variant, the boundary conditions for the kerbs of the pavement are taken into account in only one of the directions X or Y, on condition that this direction does not coincide with the direction in which the pavement 2 extends, that is to say there exists at least one point of intersection between this direction and one of the lateral edges of the pavement 2. In this manner, the accuracy and the reliability of the determination of the mechanical characteristics of the pavement, although less accurate relative to the case where the boundary conditions are taken into account in the directions X and Y, are nonetheless improved, while easing the implementation of the determination.

The zone 19 may be defined differently and may in particular exhibit a different shape. For example, the kerbs encompassed by the zone 19 comprise the zones 14, 16 and also the zone 18. In this case, the boundary conditions of the model are adapted accordingly, in particular if the zone 18 exhibits a different nature from that of the zones 14 and 16. For example, this zone 18 is an earth verge.

For example, the zone 19 moves along the pavement 2 as the vehicle applying the mechanical excitation moves over the surface 20.

As a variant, the layer C_{N} does not rest on a bed, but itself forms a bed on which the other layers rest. This layer C_{N} then exhibits for example a thickness at least ten times or a hundred times greater than the thickness of the other layers, such that this layer C_{N} is modellable by a semi-infinite layer extending indefinitely in the direction Z in a sense opposite to that of the surface 20. Here, the thickness of a layer is presumed homogeneous and is measured in the direction Z. In this case, the boundary conditions in the direction Z for this layer C_{N} are modified accordingly, for example by imposing a zero value of displacement at infinity along Z.

As a variant, the unit 30 is onboard a vehicle travelling over or in proximity to the pavement 2. For example, this vehicle is the same as that which causes the excitation during step 106. The unit 30 can also be placed somewhere remote from the zone 19 and from the pavement 2, for example in a single site centralizing the monitoring of several pavements identical to the pavement 2. A collector is then placed in the zone 19 so as to collect the data emitted by the sensors 40 and to relay these data to the unit 30.

As a variant, the sensors 40 are not buried. One or more of the sensors 40 may also straddle two layers.

The sensor 40 may be different. In particular, the assembly 44 may be different. For example, the transducer 60 is replaced with an acoustic sensor, able to measure a pressure field in the layer. This acoustic sensor is for example an electret microphone or one based on lead zirconate titanate (PZT) ceramic. The transducer 60 may also be replaced with a geophone.

In the case where the element 44 does not comprise any accelerometer, then the measurement of the speed V during step 106 is implemented in a different manner, for example according to the manner described in the document “Acoustic Sensor Network for Vehicle Traffic Monitoring” by B. Barbagli et al; VEHICULAR 2012: The First International Conference on Advances in Vehicular Systems, Technology and Applications, 2012.

The position of the sensors 40 in the pavement 2 is not necessarily known. The same goes for their directions of measurement. Indeed, these sensors may have been disposed randomly in the pavement 2, for example at the time of the construction of this pavement 2. In this case, step 100 comprises a prior operation of pinpointing these sensors. For example, a predefined excitation is applied to the pavement and the response of each of the sensors is measured, to determine their directions of measurement. Simultaneously, the position of these sensors is identified with the aid of the identifier and by triangulation during reception of the signals emitted by each sensor 40. In another example, the estimation of the directions of measurement of the sensors is performed by means of a procedure known per se for estimating static attitude, on the basis of the data measured by the three-axis accelerometer and the three-axis magnetometer.

Sensors 40 may be present in the pavement 2 outside of the zone 19. For example, sensors 40 are placed over the whole of the length of the pavement 2. On account of the limited sensitivity of the sensors, it is however considered that the sensors situated outside of the zone 19 measure only a zero displacement.

The sensors 40 may not be placed in all the layers C₁ to C_{N}. For example, all the sensors 40 are placed inside the layer C_{N}.

The interface 46 may comprise an antenna extending outside the shell 42, or else over an exterior face of this shell 42. As a variant, the interface 46 comprises a wire link connected to the interface 36.

The module 48 may be different. This module 48 may comprise a wire-based or wireless power supply system allowing it to be recharged by an energy source outside the pavement 2.

The temperature probe 62 may be different. For example, this probe 62 is a platinum probe, such as a PT100 probe. The probe 62 may also be omitted if it is chosen not to measure the temperature.

The displacement field may be measured differently. For example, the displacement of one of the sensors is recorded following the start of the excitation. The instant t_{MAX} (at which this displacement attains its maximum value is logged. Thereafter, only the displacements D(Xᵢ, t_{MAX}) are taken into account in determining the k mechanical parameters. Thus, the time dependency may be omitted, thereby simplifying the characterization of the k mechanical parameters.

During step 104, several vehicles may travel simultaneously over the pavement 2. Step 108 then comprises an operation of processing the data measured during step 106 so as to separate the contributions of each of these vehicles, according to procedures for separating sources known in the field of sensors for urban traffic management.

As a variant, the value of the speed V is measured with additional sensors distinct from the elements 44 used to measure the displacements. These additional sensors may be located in the pavement 2 outside the sensors 40 or outside the pavement 2.

The mass M may be measured differently, for example by means of the accelerometers 60 according to known techniques, such as that described in the document “Vehicle weight estimates using a buried three-axis seismometer” by J. LeMond et al.; Part of the SPIE Conference on Sensors, C31, Information and Training Technologies for Law Enforcement, Boston, Mass., SPIE Vol. 3577, November 1998. In this case, the number of sensors 40 inside each layer may be greater than that described. The magnetometer 64 may then be omitted.

The values of the characteristics M and V may already be known, for example when step 104 is implemented by means of a gauge vehicle. In this case, step 108 and the magnetometer 64 are omitted.

Step 104 may be implemented by means of a falling weight deflectometer. In this case, equivalent characteristics M and V are defined for the model, as a function of the deflectometer adjustment parameters. The person skilled in the art is indeed aware that there exists an empirical correspondence between the characteristics M, V and the deflectometer adjustment parameters. For example, it is possible to construct a model which accepts the characteristics of the falling load. In this case, step 106 is omitted

Other moduli of elasticity may be used, such as the Lame coefficients. In this case, the model is adapted accordingly. The person skilled in the art is aware that relationships exist which mutually relate these various moduli of elasticity.

Other inversion procedures may be used during step 110 to invert the pavement model.

1-12. (canceled)

13. A method for characterizing k mechanical parameters of a pavement, the pavement being formed by a stack in a direction Z of N layers and delimited by lateral edges, where k and N are non-zero integers, the method comprising:
a) applying a load to the pavement to deform the pavement;
b) in response, measuring deformation of the pavement at various points with aid of displacement sensors situated at each of the points;
c) determining k mechanical parameters on the basis of the measurements of the various sensors and of a predetermined model relating the displacements measured by each sensor to the characteristics of the load applied during a), the model being parametrized by known position of the various sensors with respect to the pavement and by the k mechanical parameters to be characterized;
wherein:
during b), the measuring is carried out by at least k sensors buried inside the pavement and distributed in at least two non-parallel directions X and Y perpendicular to the direction Z; and
during c), the determining of the k parameters is also obtained on the basis of known boundary conditions on the lateral edges of the pavement.

14. A method according to claim 13, wherein deformation of the pavement during a) comprises displacement on the pavement of an automotive vehicle of mass M at a constant speed V, and the model used during c) is also parametrized by the speed V and the mass M to characterize the load applied during a).

15. A method according to claim 14, wherein a) comprises measuring the mass M and of the speed of displacement V of the vehicle moving over the pavement.

16. A method according to claim 15, wherein the measuring the speed of displacement V is carried out by the same sensors as those used during b).

17. A method according to claim 13, wherein:
N is greater than or equal to two;
during b), the number of sensors used buried inside each layer is greater than or equal to the number of mechanical parameters of the layer to be determined during c).

18. A method according to claim 13, wherein, during c) the model comprises, for each of the N layers, a predetermined sub-model of mechanical behaviour of the layer, relating the displacements measured inside the layer to the mechanical excitations undergone by the layer at its interfaces with the other layers which are adjacent to the layer.

19. A method according to claim 13, wherein the k mechanical parameters are moduli of elasticity.

20. A method for monitoring appearance of a defect in a pavement, the method comprising:
implementing a method for characterizing k mechanical parameters of the pavement, in accordance with claim 13;
automatic comparison of each of the k characterized mechanical parameters with a reference interval predefined for the parameter, the pavement being considered to exhibit a defect only if at least one of the k characterized mechanical parameters does not belong to the corresponding predefined reference interval.

21. A non-transitory computer readable recording medium, comprising instructions for execution of c) of a method in accordance with claim 13 when the instructions are executed by an electronic computer.

22. A device for characterizing k mechanical parameters of a pavement, wherein the device comprises:
a plurality of sensors, each configured to measure a displacement and to transmit a result of the measurement to an electronic computer, the sensors being further configured to withstand passage of vehicles when they are buried in a pavement;
an electronic computer, programmed to execute c) of claim 13 with aid of the measurements transmitted by the plurality of sensors.

23. An instrumented pavement comprising:
N layers stacked in a direction Z, wherein N is a non-zero integer;
a device for characterizing k mechanical parameters of the pavement, in accordance with the device of claim 22, the sensors being buried inside the pavement.

24. A device according to claim 22, wherein the sensors comprise three-axis accelerometers.

25. A pavement according to claim 23, wherein the sensors comprise three-axis accelerometers.
